(19) United States
(12) Patent Application Publication
(10) Pub. No.: US 2015/0094134 A1
(43) Pub. Date: Apr. 2, 2015

(54) SYSTEM AND METHODS FOR PROVIDING ONLINE CASINO GAMES WITH REDEEMABLE CONSUMER REWARDS

(71) Applicant: Frederick D. Noyes, Trenton, ME (US)

(72) Inventor: Frederick D. Noyes, Trenton, ME (US)

(21) Appl. No.: 14/043,452

(22) Filed: Oct. 1, 2013

(51) Int. Cl. G07F 17/32

(52) U.S. Cl. CPC G07F 17/3244
USPC 463/25

(57) ABSTRACT

A system and method for providing online casino games to a user with redeemable commercial rewards is described herein. The system and method includes receiving, via a user computing device, a redemption request from a user to redeem a consumer reward and generating an amount of virtual credits as a function of the consumer reward in response to the received redemption request. A casino-type game is displayed on the user computing device and the user is allowed to place a wager on an outcome of the casino-type game. The wager includes an amount of virtual credits. The system and method includes determining an outcome of the casino-type game and resolving the wager as a function of the amount of virtual credits wagered and the casino-type game outcome.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The subject matter disclosed herein relates generally to playing online casino-type games and more particularly, to systems and methods for allowing users to play online casino-type games with consumer rewards, and allowing users to redeem consumer rewards for game credits for use in wagering on the casino-type games.

### BACKGROUND OF THE INVENTION

Consumer rewards have become a popular promotional tool used by commercial retail establishments to retain consumer interest and entice retail customers to purchase goods and/or services being offered by the corresponding commercial retail establishments. At least some known retail establishments have implemented consumer retention rewards programs that include issuing consumer rewards in the form of rewards points that may be accumulated by retail customers and exchanged for additional products and services offered by the commercial retail establishments.

At least some known consumer rewards programs provide consumer rewards that may only be redeemed for a limited number of products and/or services. As such, consumers may become frustrated with a lack of selection of product and/or services that may be purchased with the use of the consumer rewards. Accordingly, there is a continued need for systems and methods that create, provide and facilitate new and interesting consumer rewards programs.

### SUMMARY OF THE INVENTION

The invention is generally directed to systems and methods for allowing a player to play an online casino-type game using redeemable consumer rewards.

In one aspect of the invention, a method of allowing a player to play a casino-type game is provided. The method includes the steps of receiving, via a user computing device, a redemption request from a user to redeem a consumer reward, generating an amount of virtual credits as a function of the consumer reward in response to the received redemption request, displaying a casino-type game on the user computing device, and allowing the user to place a wager including an amount of virtual credits on an outcome of the casino-type game. The method also includes the steps of determining an outcome of the casino-type game and resolving the wager as a function of the amount of virtual credits wagered and the casino-type game outcome.

In another aspect of the invention, a system for allowing a user to play casino-type games is provided. The system includes a user computing device and a system controller connected to the user computing device. The user computing device includes a user input device for accepting a user's selection input and a display device. The system controller is configured to receive, via the user computing device, a redemption request from a user to redeem a consumer reward, generate an amount of virtual credits as a function of the consumer reward in response to the received redemption request, display a casino-type game on the user computing device, and allow the user to place a wager including an amount of virtual credits on an outcome of the casino-type game. The system controller is also configured to determine an outcome of the casino-type game and resolve the wager as a function of the amount of virtual credits wagered and the casino-type game outcome.

In yet another aspect of the invention, one or more non-transitory computer-readable storage media, having computer-executable instructions embodied thereon is provided. The computer-executable instructions, when executed by at least one processor, cause the processor to receive a redemption request from a user to redeem a consumer reward, generate an amount of virtual credits as a function of the consumer reward in response to the received redemption request, display a casino-type game, and allow the user to place a wager including an amount of virtual credits on an outcome of the casino-type game. The computer-executable instructions also cause the processor to determine an outcome of the casino-type game and resolve the wager as a function of the amount of virtual credits wagered and the casino-type game outcome.

### BRIEF DESCRIPTION OF THE DRAWINGS

Other advantages of the invention will be readily appreciated as the same becomes better understood by reference to the following detailed description when considered in connection with the accompanying drawings wherein:

FIG. 1 is a schematic representation of an exemplary system for use in allowing a user to play a casino-type game with consumer rewards, according to an embodiment of the present invention;

FIG. 2 is a schematic representation of a controller that may be used with the system shown in FIG. 1, according to an embodiment of the present invention;

FIG. 3 is a flowchart of a method that may be used with the system shown in FIG. 1 for allowing a user to play an online casino-type game via a user computing device with consumer rewards, according to an embodiment of the invention;

FIG. 4 is an exemplary graphical display of an online casino selection screen that may be used with the method shown in FIG. 2, according to an embodiment of the present invention;

FIG. 5 is an exemplary graphical display of a rewards redemption selection screen that may be used with the method shown in FIG. 2, according to an embodiment of the invention;

FIG. 6 is an exemplary graphical display of a game selection screen that may be used with the method shown in FIG. 2, according to an embodiment of the present invention;

FIG. 7 is an exemplary entertaining graphical display of a simulated casino-type game that may be used with the method shown in FIG. 2, according to an embodiment of the present invention;

FIG. 8 is an exemplary graphical display of a credit exchange selection screen that may be used with the method shown in FIG. 2, according to an embodiment of the invention; and

FIG. 9 is a schematic view of a user computing device that may be used with the method shown in FIG. 2, according to an embodiment of the present invention.

Corresponding reference characters indicate corresponding parts throughout the drawings.

### DETAILED DESCRIPTION OF THE PREFERRED EMBODIMENT

The exemplary embodiments herein relate to online casino-type games. It should be understood that each of the methods and individual steps recited herein may be partially or wholly carried out in a variety of ways and/or systems, which may include, but are not limited to, a multiplayer platform which may include a player interface such as a touchscreen display and involve physical or virtual game symbols, a home computer and/or portable computing device, such as a tablet computer or mobile phone capable of communicating with a network or over the Internet, global telecommunication network or world wide web.

It should further be understood that the invention is directed to, among other things, methods of providing, conducting and resolving wagering games that include a sequence of controlled and concrete transformative events. Some of these events may involve wagering, the generation of random data, the application of randomly-generated data to predefined rules, the determination of wager outcomes in accordance with preset outcome determining criteria, the notification of such outcomes, awarding of payouts and collecting of wagers. The generation of random data may be facilitated by computerized and/or physical implements. The transformative events may also include parsing of the data for comparative purposes with preset criteria to determine an outcome in a second, bonus or associated wagering game.

With reference to the drawings and in operation, the invention overcomes at least some of the disadvantages of known consumer rewards systems by providing, among other things, systems and methods which enable a user to redeem one or more consumer rewards for virtual game credits that may be used to place wagers on casino-type games. Moreover, the system and methods provide an opportunity to increase an amount of consumer rewards available to a user by allowing the user to exchange a consumer reward for game credits, wager the game credits on the outcome of the casino-type games, and to exchange the game credits for different consumer rewards. By providing a system and method that allows a user to wager consumer rewards on online casino-type games, the probability of increasing the value of the consumer reward is increased and the enjoyment in the use of consumer rewards is increased, thus increasing the effectiveness of the consumer retention rewards program over known consumer reward programs.

The invention is generally directed to systems and methods for promoting and facilitating the sale of goods and/or services by allowing players to redeem consumer rewards for virtual credits and play online casino-type games using the virtual credits. In general, the system includes an online or internet casino program designed specifically for consumer corporation rewards programs. The process includes a company with rewards points allowing its customers the option to go to the online casino rewards program site and exchange said rewards points for virtual currency. The virtual currency is then usable on the site for gaming purposes, that is, to be gambled in familiar casino games including poker, blackjack, roulette, baccarat, video poker, slots, and other games of skill and chance. After a customer has been on the online casino rewards program site and either lost all of his or her virtual currency or won additional virtual currency he/she can then exchange the virtual currency back into rewards points associated with a variety of corporations offering the rewards points as part of their marketing programs. As part of the online casino rewards program each company that signs on to the web-based site will have a prearranged exchange value for its rewards points and the website's virtual currency. Players, when exiting the online casino rewards program will be required to exchange their virtual currency for rewards points from corporations that are part of the program. The unique online casino rewards program, the playing of the various standard casino games, and the exchanging of virtual currency for rewards points to and from the member corporations will all be accessed through the database under control of the provider.

It is an object of the present invention to provide a unique process whereby corporate rewards points are increased or decreased in number through gambling online. Further, the invention will provide the customers or players of the corporate members to the website the unique opportunity to exchange rewards points from one corporate provider to another via the exchange rate as determined by virtual currency. Additionally, a corporate member to the online casino rewards program may reduce its customer liability in total or individually by losses incurred by Players during their gaming experience. These and other objectives are achieved in the present invention by providing a comprehensive online casino that facilitates the opportunity for corporate customers/Players to increase their virtual currency value and exchange same for increases in rewards points for different member companies.

The online casino rewards program system of the present invention includes a series of steps related to the increase or decrease of a specific corporation's rewards points through a web-based online casino. Corporations with point rewards programs are charged with becoming members of the online casino rewards program thereby allowing their customers to either increase or decrease the number of rewards points by participating in an online casino. The first step in the process is for customers of member corporations to login to the web-based casino. Member corporations will have links to the web-based casino explaining to their customers that they have the opportunity to gamble for more reward points as well as the opportunity to exchange their rewards points for points from other member companies. Customers/Players that choose to login to web-based casino will be brought to a site within the web-based casino where they must exchange their rewards points for virtual currency. The virtual currency will be the currency of usage for a menu of casino games, including but not limited to poker, blackjack, roulette, baccarat, video poker, and slots. Upon the loss of all virtual currency the customer/player shall be directed to logout of the site. When a customer/player choose to leave the online casino where they will be directed to the virtual currency exchange for rewards points. These rewards points will come from the member corporations allowing the customers/players access to their sites and to participate in their rewards programs.

As described herein, the term “consumer reward” refers to any award and/or reward provided to a consumer to promote the purchase and/or use of a consumer product and/or service. For example, a consumer reward may include, but is not limited to, products, services, promotional consumer offerings, coupons for consumer products and/or services, rewards points awarded to a consumer for the purchase of goods and/or services from a commercial establishment and redeemable for additional products and/or services, discounted product/service pricing, and/or any suitable reward provided to a consumer for use in promoting the sale and/or use of a product and/or service by the consumer. In the illustrated embodiment, the commercial establishment may include, but is not limited to including, a retail store, a grocery store, a restaurant, a gas station, an online retail store, a travel service company, a service company, a hotel, a casino, an amusement park, a theater, a movie theater, a museum, and/or any commercial establishment that offers goods and/or services for purchase by a consumer.

A selected embodiment of the invention will now be explained with reference to the drawings. It will be apparent to those skilled in the art from this disclosure that the following description of the embodiment of the invention is provided for illustration only and not for the purpose of limiting the invention as defined by the appended claims and their equivalents.

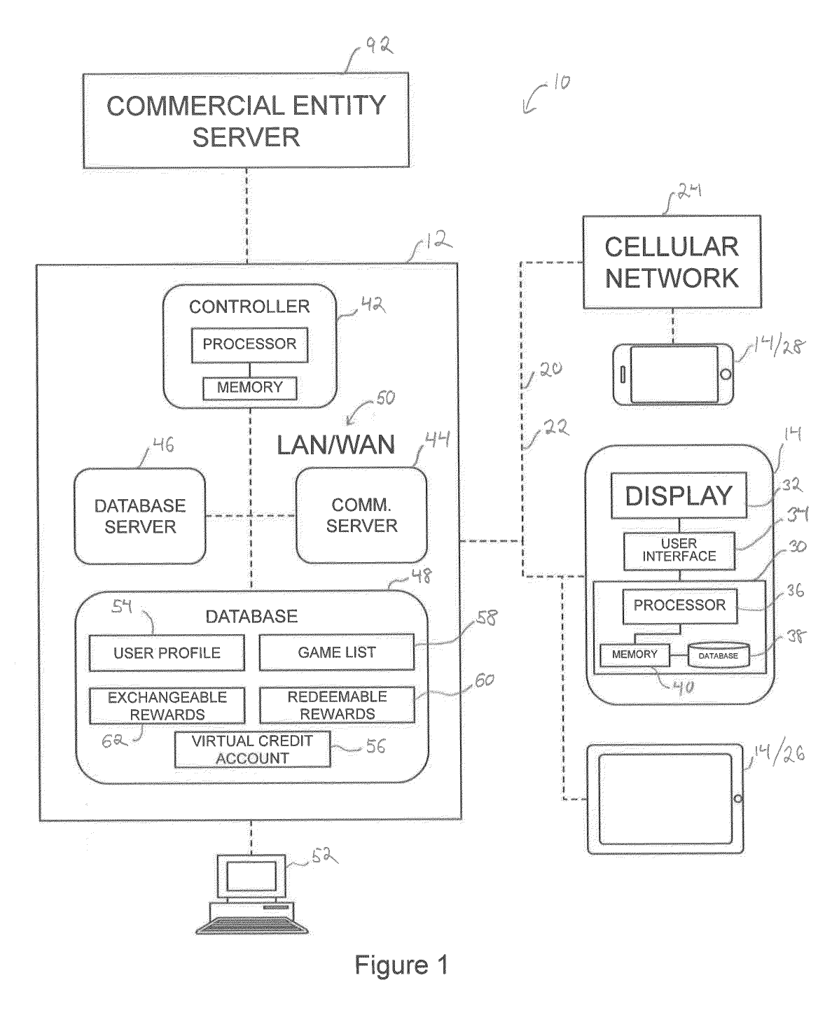

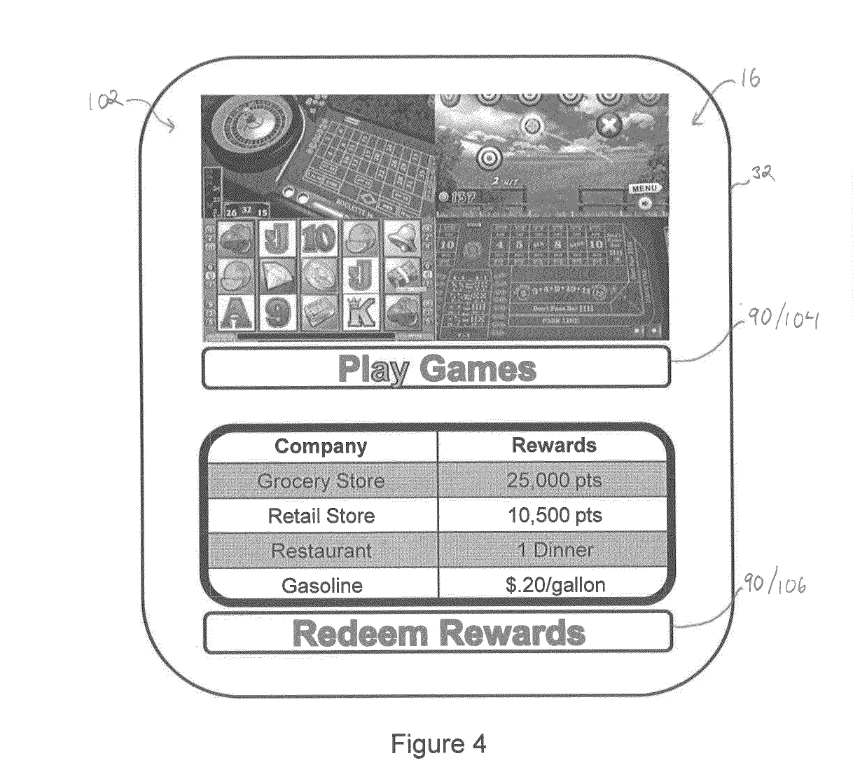

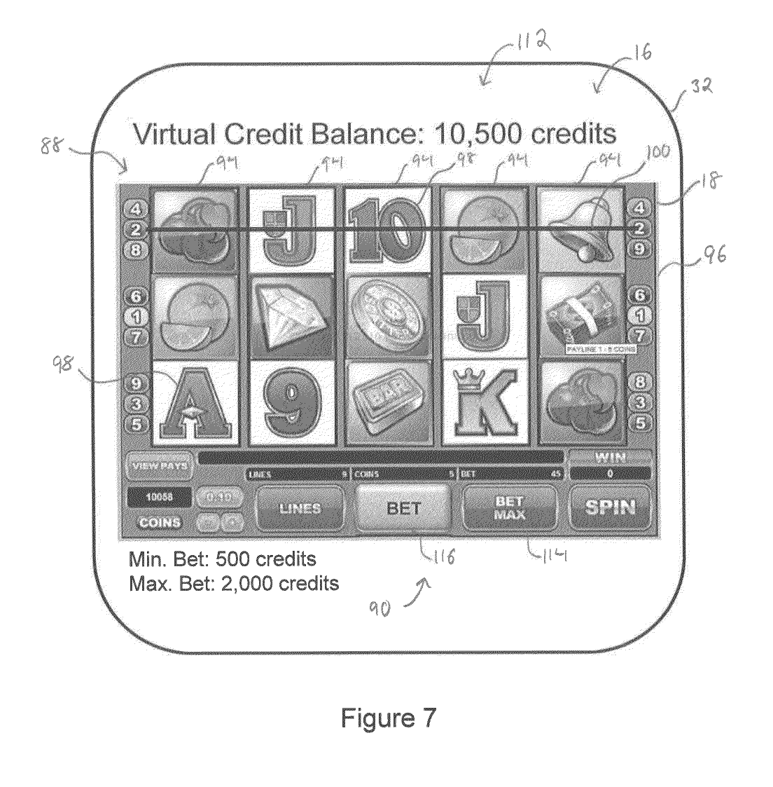

FIG. 1 is a schematic representation of the system 10, according to an embodiment of the invention. In the illustrated embodiment, the system 10 includes a server system 12 that is coupled to one or more user computing devices 14. Each user computing device 14 is configured to transmit and receive data to and/or from the server system 12 to display graphical interfaces 16 (shown in FIGS. 4-8) to enable a user to participate in game such as, for example, an online casino-type game 18 (shown in FIG. 7) using consumer rewards via the user computing device 14. In the illustrated embodiment, the server system 12 is coupled in operative communication with each user computing device 14 via a communications link 20 that enables each user computing device 14 to access the server system 12 over a network 22, such as the Internet, a cellular network 24, a wireless network and/or any suitable telecommunication network that enables the user computing devices 14 to access the server system 12. For example, in one embodiment, the user computing device 14 includes a mobile computing device 26, e.g. a smartphone 28 that communicates with the server system 12 via the cellular network 24 and/or the Internet. In another embodiment, the user computing device 14 may include a personal computer, laptop, cell phone, tablet computer, smartphone/tablet computer hybrid, personal data assistant, and/or any suitable computing device that enables a user to connect to the server system 12 and display the graphical interfaces 16.

In the illustrated embodiment, each user computing device 14 includes a device controller 30 that is coupled to a display device 32 and a user input device 34. The display device 32 includes, without limitation, a flat panel display, such as a cathode ray tube display (CRT), a liquid crystal display (LCD), a light-emitting diode display (LED), active-matrix organic light-emitting diode (AMOLED), a plasma display, and/or any suitable visual output device capable of displaying graphical data and/or text to a user. Moreover, the user input device 34 includes, without limitation, a keyboard, a keypad, a touch-sensitive screen, a scroll wheel, a pointing device, a barcode reader, a magnetic card reader, a radio frequency identification (RFID) card reader, an audio input device employing speech-recognition software, and/or any suitable device that enables a user to input data into the device controller 30 and/or to retrieve data from the device controller 30. Alternatively, a single component, such as a touch screen, a capacitive touch screen, and/or a touchless screen, may function as both the display device 32 and the user input device 34.

In the illustrated embodiment, the device controller 30 includes a processor 36, a database 38, and a memory device 40 that is coupled to the processor 36 and the database 38. The memory device 40 includes a computer readable medium, such as, without limitation, random access memory (RAM), read-only memory (ROM), erasable programmable read-only memory (EPROM), flash memory, a hard disk drive, a solid state drive, a diskette, a flash drive, a compact disc, a digital video disc, and/or any suitable device that enables the processor 36 to store, retrieve, and/or execute instructions and/or data. The processor 36 executes various programs, and thereby controls other components of the device controller 30 and the user computing device 14 according to user instructions and data accepted by the user input device 34. The processor 36 in particular displays the graphical interface 16 (shown in FIGS. 4-8), and thereby enables the system 10 to generate lists of consumer rewards and to allow the user to exchange the consumer rewards for virtual credits for use in wagering on casino-type games in response to user instructions received via the user computing devices 14 in accordance with the embodiments described herein. The memory device 40 stores programs and databases used by the processor 36. Moreover, the memory device 40 stores and retrieves information in the database 38 including, but not limited to, image data for producing images and/or screens on the display device 32, and temporarily stores variables, parameters, and the like that are used by the processor 36.

In the illustrated embodiment, the server system 12 includes a system controller 42, a communications server 44, a database server 46, and a database 48. The system controller 42 is connected to the servers 44 and 46 and the database 48 through a network 50 such as, for example, a local area network (LAN), a wide area network (WAN), dial-in-connections, cable modems, wireless modems, and/or special high-speed Integrated Services Digital Network (ISDN) lines. Moreover, at least one administrator workstation 52 is also coupled to the network 50 to enable communication with the server system 12. Alternatively, the workstation 52 may be coupled to the network 50 using an Internet link or may be coupled through an intranet.

The system controller 42 includes a processor and a memory device connected to the processor. The memory device includes a computer readable medium that enables the processor to store, retrieve, and/or execute instructions and/or data to execute various programs, and thereby controls other components of the system controller 42 and/or server system 12.

The communications server 44 communicates with each of the user computing devices 14 and the administrator workstation 52 to facilitate transmitting data over the network 22 via the Internet and/or the cellular network 24, respectively.

The database server 46 is connected to the database 48 to facilitate transmitting data to and from the database 48. The database 48 contains information on a variety of matters, such as, for example, account information related to a user, user profile information, casino-type games, wagering credit accounts, consumer rewards, exchangeable consumer rewards, redeemable consumer rewards, consumer rewards exchange rates, consumer rewards redemption rates, and/or image data for producing game images and/or screens on the user computing device 14 and temporarily stores variables, parameters, and the like that are used by the system controller 42 and/or the device controller 30. In one embodiment, the database 48 includes a centralized database that is stored on server system 12 and is accessed directly via the user computing devices 14. In an alternative embodiment, the database 48 is stored remotely from the server system 12 and may be non-centralized.

In the illustrated embodiment, the database 48 includes a user profile list 54, a virtual credit account list 56, a game list 58, a redeemable rewards list 60, and an exchangeable rewards list 62. The user profile list 54 includes a plurality of user profile accounts and a plurality of corresponding unique user identifiers. For example, in one embodiment, the unique user identifier may include a combination of a username and password. Alternatively, in another embodiment, the unique user identifier may include a personal identification number, or a random identification number assigned to a corresponding user account. In the illustrated embodiment, the system 10 uses the unique user identifier to identify the user and provide access to the server system 12 via a user computing device 14 associated with the unique user identifier. For example, in one embodiment, the unique user identifier may include a mobile device identifier, such as, for example, a cellular phone number and/or wireless internet address for identifying a user computing device 14 associated with a user account.

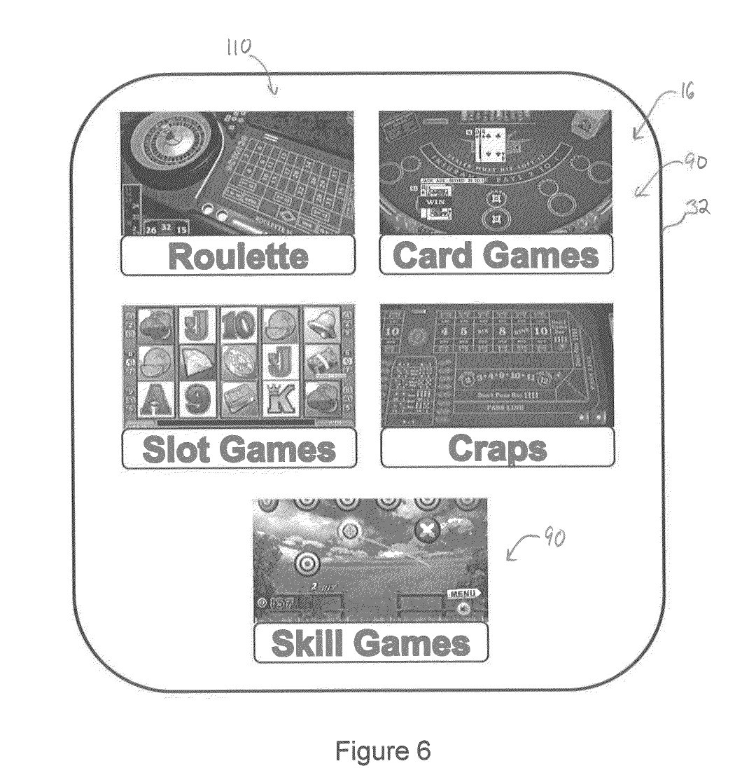

The virtual credit account list 56 includes a plurality of virtual credit accounts that are associated with each user profile account. Each virtual credit account includes financial account information associated with the corresponding user profile account. The financial account information may include, but is not limited to, an amount of game credits available for use in playing games, available commercial rewards for use in purchasing game credits and/or exchanging for game credits, an available game credit account balance, and/or any suitable financial information that enables the system 10 to function as described herein. The game list 58 includes data related to a collection of simulated casino-type games 18 (shown in FIGS. 6 and 7) that are available for play by the user. The simulated casino-type games may include, but are not limited to, a video slot game, a keno game, a blackjack game, a video craps game, a video poker game, or any casino-type of game which allows a user to place a wager, play a game, and potentially provide the player an award. In addition, the game list 58 may also include data related to skill-based games that provide an award to the player as a function of the player's selection. In some embodiments, the skill-based game may include any game that allows the player, i.e. the user, to affect the outcome of the skill-based game through a series of player choices and/or player selections. The skill-based game may also include a player skill component associated with the player's selection that may include physical or manual dexterity, digital dexterity, hand-eye coordination (e.g., aim), reflexes, memory, cognitive processing, knowledge, and/or strategy-based selection. Skill-based games may include, but are not limited to including, target shooting games, catapult-type games, sporting games, memory games, matching games, and/or any suitable game that includes a skill component and that enables the outcome of the game to be at least partially determined based on a player selection, i.e. a user selection.

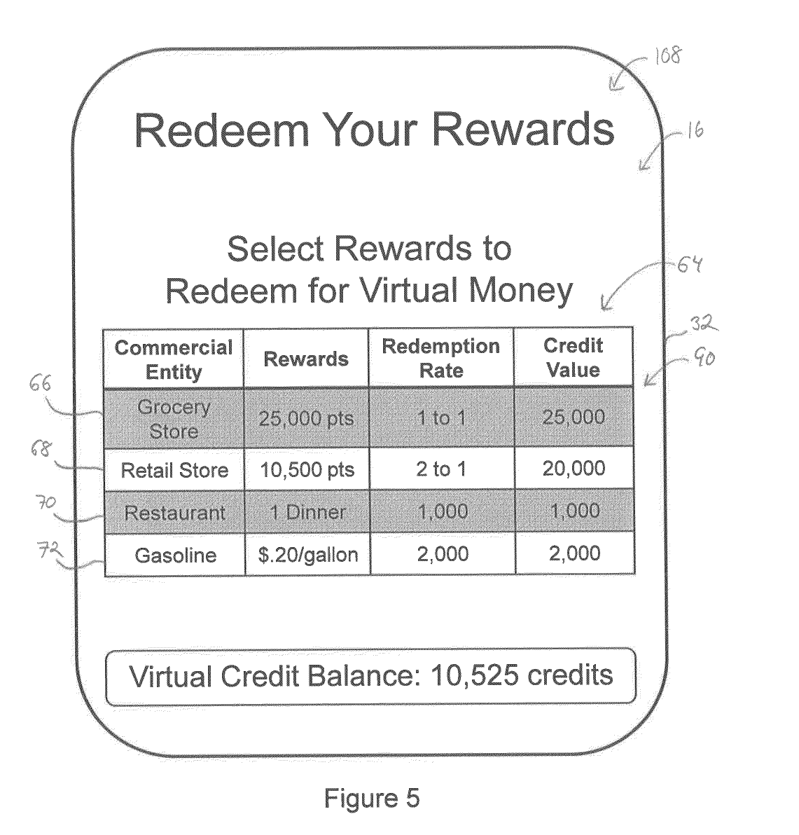

The redeemable rewards list 60 includes information related to a collection of redeemable consumer rewards 64 (shown in FIG. 5) that may be redeemed for an amount of game credits that may be used in placing wagers associated with the casino-type games. The consumer reward information may include, but is not limited to including, a type of consumer rewards, a commercial entity associated with each consumer reward, an amount of consumer rewards, categories of types of consumer rewards, and/or any suitable consumer reward information. In addition, the redeemable rewards list 60 may also include a list of redeemable consumer rewards associated with each user profile account. In the illustrated embodiment, each redeemable consumer reward contained in the redeemable rewards list 60 includes a redemption rate that is indicative of an equivalent value of virtual game credits associated with the corresponding redeemable consumer reward. The redemption rate may be, for example, an amount of equivalent game credits, a ratio of reward points to game credits, a percentage of game credits, and/or any suitable rate for use in determining an amount of game credits as a function of a consumer reward. In one embodiment, the redemption rate associated with each redeemable consumer reward may be approximately the same. In another embodiment, at least two redemption rates associated with the redeemable consumer rewards may be different. For example, in one embodiment, the redeemable rewards list 60 may include a first redeemable consumer reward having a first redemption rate and a second redeemable consumer reward having a second redemption rate that is different than the first redemption rate. As shown in FIG. 5, in one embodiment, the redeemable rewards list 60 may include a plurality of redeemable consumer rewards 64 associated with a user profile account. The plurality of redeemable consumer rewards 64 may include, for example, a grocery store reward 66, a retail store reward 68, a restaurant reward 70, and a gasoline reward 72. Each consumer reward includes information indicative of a commercial establishment associated with the reward, a type of reward, and amount of reward, and a redemption rate associated with the reward.

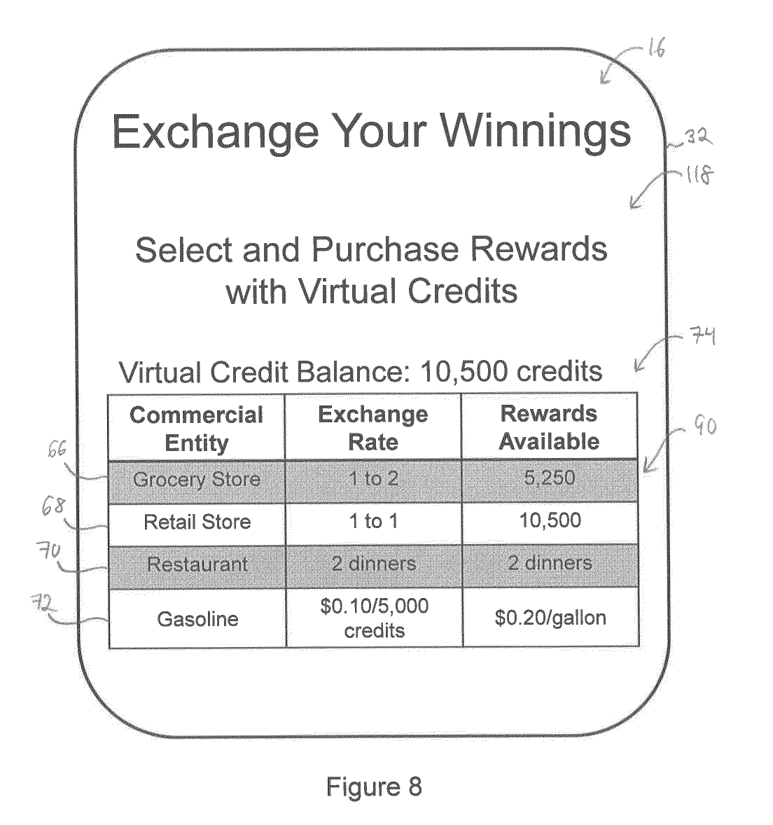

Similarly, the exchangeable rewards list 62 includes information related to a collection of exchangeable consumer rewards 74 (shown in FIG. 8) that are available for purchase using game credits. The exchangeable rewards list 62 includes a plurality of exchangeable consumer rewards associated with each user profile account. In one embodiment, the exchangeable consumer rewards 74 associated with a user profile account are substantially similar to the redeemable consumer rewards 64 associated with the user profile account. The exchangeable consumer rewards 74 may be different from the redeemable consumer rewards 64 associated with the user profile account.

In the illustrated embodiment, each exchangeable consumer reward 74 includes a corresponding exchange rate that is indicative of an equivalent value of game credits that are required to purchase a corresponding amount of exchangeable consumer rewards 74. The exchange rate may be, for example, an amount of equivalent game credits associated with a consumer reward, a ratio of game credits to reward points, a percentage of game credits, and/or any suitable rate for use in determining an amount of game credits required to purchase a corresponding amount of consumer rewards. In one embodiment, each consumer reward may include a corresponding redemption rate and a corresponding exchange rate. In the illustrated embodiment, the corresponding redemption rate may be approximately equal to the corresponding exchange rate. Alternatively, the corresponding redemption rate may be different from the corresponding exchange rate.

In one embodiment, as shown in FIG. 8, the exchangeable rewards list 62 may include a plurality of exchangeable consumer rewards 74 associated with a user profile account. The plurality of exchangeable consumer rewards 74 may include, for example, the grocery store reward 66, the retail store reward 68, the restaurant reward 70, and the gasoline reward 72. Each consumer reward includes information indicative of a commercial establishment associated with the reward, a type of reward, and amount of reward, and an exchange rate associated with the reward.

In the illustrated embodiment, the workstation 52 includes a display and user input device to enable an administrative user to access the server system 12 to transmit data indicative of the casino-type games and/or the consumer rewards to the database server 46. This enables an administrative user to periodically update the user profile list 54, a virtual credit account list 56, a game list 58, a redeemable rewards list 60, and an exchangeable rewards list 62, game types, wager types, available rewards, user profile accounts, and/or any suitable data and information that enables the system 10 to function as described herein.

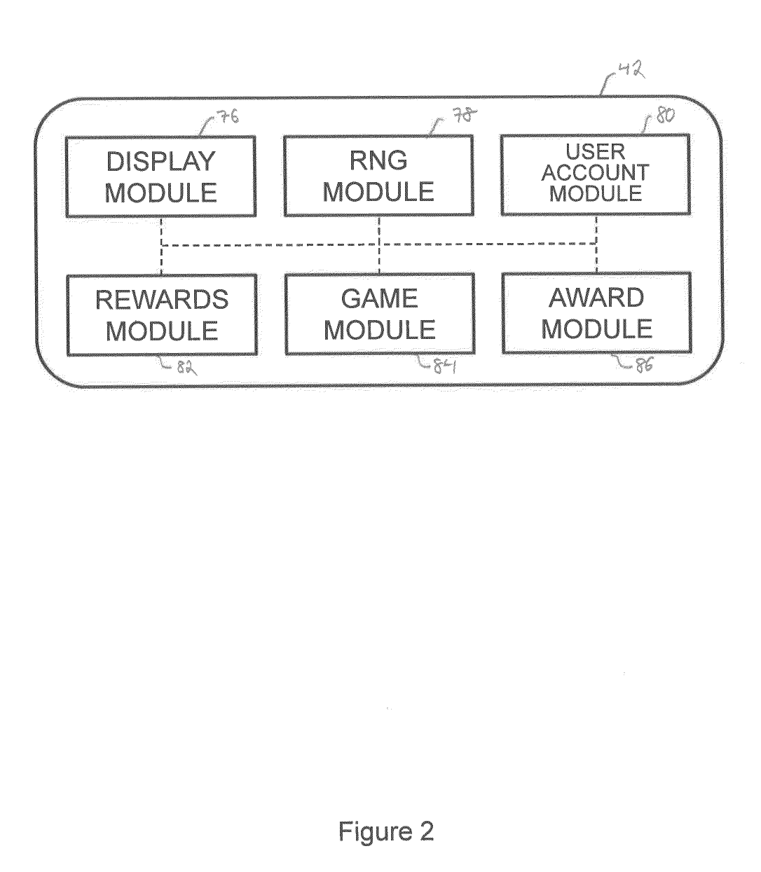

FIG. 2 is schematic view of the system controller 42. In the illustrated embodiment, the system controller 42 includes a display module 76, a random-number generator (RNG) module 78, a user account module 80, a rewards module 82, a game module 84, and an award module 86.

The display module 76 controls the display device 32 to display various images on the graphical interface 16 preferably by using computer graphics and image data stored in the database 48. In the illustrated embodiment, the display module 76 is configured to display casino-type games 18 and to control the symbols being displayed in the casino-type games 18 such as, for example, a video slot-type game 88 (shown in FIG. 7) on the display device 32 by using computer graphics and the image data. In the illustrated embodiment, the display module 76 also displays a plurality of user selection areas 90 (shown in FIGS. 4-8) within the graphical interface 16 that correspond to specific operations that may be initiated by the user.

The rewards module 82 communicates with the database 48 to retrieve information indicative of the consumer rewards associated with a user profile account. For example, in one embodiment, the system controller 42 may receive a user request to redeem a consumer reward for game credits for use in placing a wager on a casino-type game 18 including a unique user identifier. The rewards module 82 identifies the user profile account associated with the unique user identifier, retrieves the consumer rewards associated with the user profile account from the redeemable rewards list 60, and displays the retrieve consumer rewards to the user on the display device 32. The rewards module 82 allows the user to select a redeemable consumer reward 64 for redemption, determines the redemption rate associated with the selected consumer reward, determines an amount of game credits associated with the selected consumer reward, and transmits data indicative of the determined game credit amount to the user account module 80.

Similarly, the system controller 42 may receive a user request to exchange an amount of game credits for one or more consumer rewards. The rewards module 82 retrieves the exchangeable consumer rewards 74 associated with the user profile account from the exchangeable rewards list 62 and displays the consumer rewards to the user via the display device 32. Upon receiving a user selection of one or more exchangeable consumer rewards 74, the rewards module 82 determines an exchange rate associated with the selected exchangeable consumer rewards 74, determines an amount of game credits being exchanged, and determines an amount of consumer rewards being provided to the user as a function of the selected exchangeable consumer reward 74, the amount of game credits, and the associated exchange rate. The rewards module 82 transmits data indicative of the purchased consumer reward to the user account module 80.

The user account module 80 communicates with game module 84, the award module 86, the rewards module 82, and the database 48 to manage the amount of game credits available for use in playing the casino-type game 18 and/or for purchasing consumer rewards. For example, in the illustrated embodiment, the user account module 80 receives a user selection indicative of a request from a user computing device 14 to place one or more wagers on the game including an amount of game credits associated with each wager. The user account module 80 identifies the user profile account associated with the request and determines if sufficient game credits are available in the user profile account as a function of the user request. If the user account module 80 determines sufficient game credits are available in the user profile account, the user account module 80 sends a verification message to the game module 84 and withholds a corresponding amount of game credits from the user profile account. If the user account module 80 determines that the user profile account does not include a sufficient amount of game credits, the user account module 80 transmits a message to the display module 76 to display a message on the user computing device 14 requesting the user to redeem additional consumer rewards for game credits. In addition, the display module 76 may also display the redeemable consumer rewards 64 associated with the user profile account that are available for use in purchasing additional game credits for playing and/or wagering on the games.

In one embodiment, the user account module 80 may be configured to generate and store player tracking data indicative of the associated user's game play such as, for example, a frequency in which the user plays a game, types of games frequently played by the user, the average wager the user makes per play of a game, a total amount wagered by the user over a predefined period of time, and/or any other suitable player tracking information. In addition, the user account module 80 may be configured to generate and store consumer rewards tracking data indicative of the user's use of consumer rewards including, but not limited to, an amount of consumer rewards being redeemed and/or exchanged over a predefined period of time, a type of consumer reward being redeemed and/or exchanged, a preferred type of consumer reward, a total amount of consumer rewards being redeemed and/or exchanged, a preferred exchange rate, a preferred redemption rate, and/or any suitable data indicative of a user's use of consumer rewards that enables the system 10 to function as described herein.

In the illustrated embodiment, the system 10 is configured to communicate with one or more third party platforms such as, for example a commercial entity server 92, for transmitting consumer rewards data and/or player tracking data associated with one or more users for use in marketing, promotions, and/or transferring consumer rewards to the user for use in point-of-service transactions involving goods and services provided to the user by the commercial entities. For example, in one embodiment, the system 10 may transit consumer rewards data and/or player tracking data associated with user profile accounts to a commercial entity via the commercial entity server 92, and receive, from the commercial entity, data indicative of consumer rewards being provided to the user by the commercial entity. For example, the system 10 may receive consumer rewards data associated with a unique user identifier from the commercial entity server 92, identify the user profile account associated with the unique user identifier and update the data contained in the associated user profile account to include the received consumer rewards.

The game module 84 includes a game program for use in playing a game based on user selection input receive from a user computing device 14. The game module 84 receives game information included in the database 48 and performs various functions and calculations to play the game according to a set of predetermined game rules and player input. More specifically, the game module 84 retrieves game elements from the database 48 and causes the display module 76 to display the game 18 on the display device 32. The game module 84 receives signals indicative of a user selection input via the user input device 34, generates an outcome of the game 18 based on the predetermined game rules and the received user selection input, and displays the game outcome on the display device 32.

The RNG module 78 generates and outputs random numbers to the game module 84 for use in playing the game 18. In addition, the game module 84 may use random numbers generated by the RNG module 78 to determine if a winning condition has occurred in the outcome of the game, and to determine whether or not to provide an award to a player. For example, if the game is the casino-type game 18, the game module 84 uses the RNG module 78 to randomly select an outcome of the game 18.

For example, in one embodiment, the game module 84 may display a casino-type slot-type game 88 (shown in FIG. 7) based on a user selection. In the illustrated embodiment, the slot-type game 88 includes a plurality of slot reels 94 being displayed in a display area 96 with each slot reel 94 displaying a plurality of game symbols 98. The slot-type game 88 also includes a plurality of pay lines 100 to indicate, to the user, a combination of game symbols 98.

In the illustrated embodiment, the slot-type game 88 is generally played in a conventional manner. The game module 84 receives a user selection input from the user computing device 14 indicative of a wager being placed by the player on the slot-type game 88 including an amount of game credits associated with the wager. The game module 84 randomly generates an outcome for the game 18, spins the reels 94, and selectively stops the reels 94 to display the game symbols 98 in the display area 96. If a predetermined pattern of symbols 98 is randomly chosen on a played payline 100, the player may be awarded a payout based on the payline, the wager, and a predetermined paytable. In the illustrated embodiment, the award module 86 compares the generated game outcome with winning combinations stored in a winning combination table to determine if the randomly generated outcome includes a winning outcome that is associated with a type of award. In addition, the award module 86 awarded a payout to the player if the combination of symbols 98 associated with a selected payline 100 is a winning combination. In the illustrated embodiment, the payout may be an amount of game credits awarded to the player as a function of the winning outcome. Many variations to the above described general play of a casino-type game fall within the scope of the present invention.

During a skill-based game, the game module 84 determines the game outcome as a function of user selections received during game play. The award module 86 determines whether an award is provided to the player based on the determined outcome. For example, in one embodiment, the award module 86 may match the determined outcome with winning outcomes stored in a winning outcome table and provide an award associated with the matched outcome, if any.

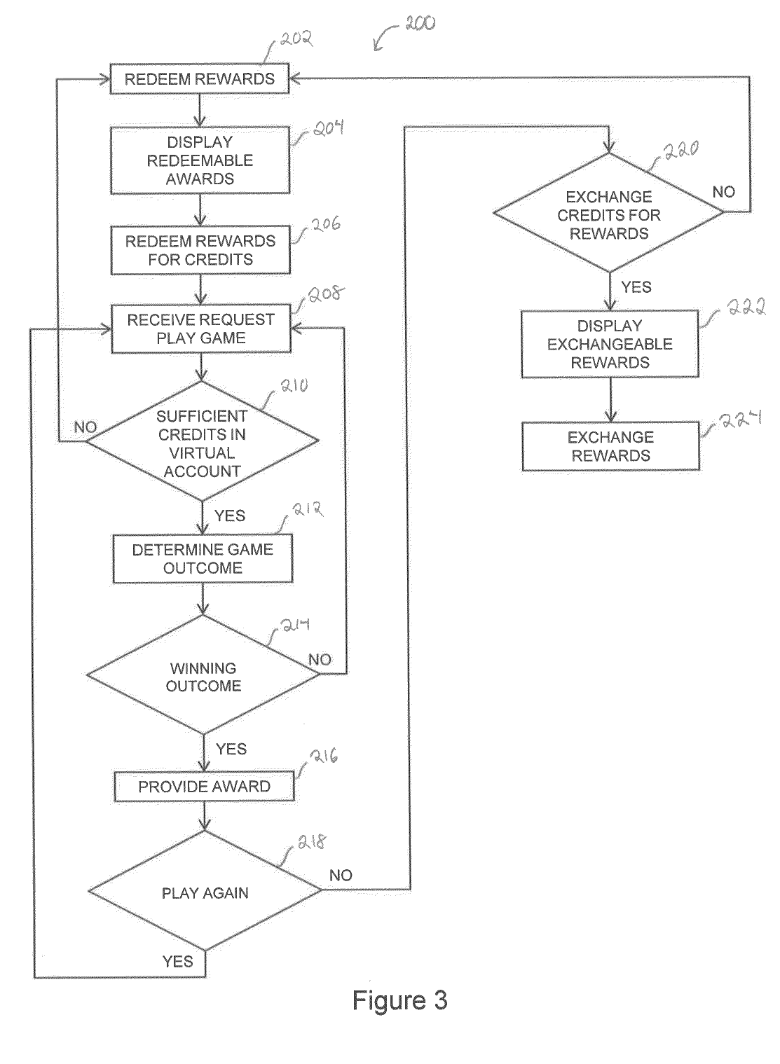

FIG. 3 is a flowchart of a method 200 that may be used with the system 10 for allowing a player to play online casino-type games with consumer rewards using a user computing device 14. Each method step may be performed independently of, or in combination with, other method steps. Portions of the method 200 may be performed by any one of, or any combination of, the components of the system 10. FIGS. 4-8 are exemplary entertaining graphical displays of various player selection screens that may be used by the system 10 with the method 200. In the illustrated embodiment, entertaining graphical displays are presented by the user computing device 14 via the display device 32 (shown in FIG. 1) and may receive input (e.g., selections and/or entries) via the user input device 34 (shown in FIG. 1). For example, in one embodiment, a selection may be received via the user computing device 14 and may be transmitted by the user computing device 14 to the server system 12 via the network 22.

In the illustrated embodiment, in the method step 202, the system controller 42 receives, via the user computing device 14, a redemption request from a user to redeem a consumer reward. In one embodiment, the user may submit the request by accessing a website via the communications server 44. In another embodiment, the player may access a mobile website via the cellular network 24. In the illustrated embodiment, the display module 76 may display a user selection screen 102 (shown in FIG. 4) and allow a user to request to redeem rewards and/or request to play games. For example, as shown in FIG. 4, in one embodiment, the display module 76 may display a “Play Games” selection area 104 and a “Redeem Rewards” selection area 106. In response to a user selection of the “Redeem Rewards” selection area 106, the system controller 42 may display a redemption selection screen 108 (shown in FIG. 5) to allow the user to redeem one or more consumer rewards for game credits. In addition, in response to a user selection of the “Play Games” selection area 104, the system controller 42 may display a game selection screen 110 (shown in FIG. 6) to allow the user to select a game for play with game credits.

In one embodiment, the system controller 42 may also receive a unique user identifier with the redemption request for use in validating the redemption request. More specifically, the display module 76 may display a login screen (not shown) on the user computing device 14 to request the unique user identifier such as, for example, requesting a username and/or password. The user account module 80 may receive the unique user identifier and compare the received unique user identifier with the collection of unique user identifier contained in the user profile list 54 to validate the unique user identifier. Upon validating the unique user identifier, the system controller 42 may display a list of redeemable consumer rewards. In addition, in one embodiment, if the received user identifier is not included in the user profile list 54, the system controller 42 may prompt the user to establish a user profile account, including identifiable personal information suitable for use in identifying the user to a commercial entity.

In method step 204, the user account module 80 identifies the user profile account associated with the received redemption request and displays the redeemable consumer rewards associated with the user profile account. More specifically, the user account module 80 receives the redemption request including a unique user identifier and identifies the user profile account associated with the unique user identifier. The rewards module 82 determines the redeemable consumer rewards associated with user profile account and displays the redeemable consumer rewards to the user. In one embodiment, the rewards module 82 may retrieve the redeemable consumer rewards from the redeemable rewards list 60 contained in the database 48. In another embodiment, the rewards module 82 may transmit a rewards request including data associated with the identified user profile account to one or more commercial entities via the commercial entity server 92. The rewards module 82 receives a verification message from the one or more commercial entities including redeemable consumer rewards associated with the user profile account and available for redemption by the user.

In the illustrated embodiment, in method step 204, the display module 76 displays the redemption selection screen 108 (shown in FIG. 5) and allows the user to select one or more redeemable consumer rewards 64. Moreover, the rewards module 82 determines the redeemable consumer rewards associated with user profile account and displays a list of redeemable consumer rewards in response to the redemption request via the redemption selection screen 108. The rewards module 82 also determines a redemption rate associated with each of the redeemable consumer rewards contained in the list of redeemable consumer rewards, and displays the associated redemption rate to the user. In one embodiment, the list of redeemable consumer rewards may include a first consumer reward having a first redemption rate and a second consumer reward having a second redemption rate that is different than the first redemption rate.

In method step 206, the system controller 42 receives a user selection indicative of at least one consumer reward contained in the list of redeemable consumer rewards and generates the amount of virtual credits as a function of the selected at least one consumer reward. More specifically, the rewards module 82 determines a value of the selected consumer reward, determines the redemption rate associated with the selected consumer reward, and generates an amount of gaming credits as a function of the selected consumer reward and the corresponding redemption rate. The user account module 80 also receives data indicative of the generated amount of game credits and adds the amount of game credits to the corresponding virtual credit account.

In method step 208, the system controller 42 receives a request from the user to play a game. More specifically, in the illustrated embodiment, the display module 76 displays a game selection screen 110 (shown in FIG. 6) including games contained in the game list 58. Each game is displayed with a corresponding selection area 90 to allow the user to select a game for play. In the illustrated embodiment, the system controller 42 allows the user to select from a plurality of casino-type games 18 and/or a plurality of skill-based games.

In method step 208, the game module 84 receives a user's selection of a game for play and responsively displays the selected game on a game screen 112 (shown in FIG. 7) via the user computing device 14. In addition, the system controller 42 allows the user to place a wager on an outcome of the game including an amount of virtual credits. For example, in one embodiment, as shown in FIG. 7, the system controller 42 may display a casino-type slot-type game 88 in response to the received user's request. In addition, the system controller 42 may also display an amount of game credits available for wagering on the game and associated with the identified user profile account. In one embodiment, the system controller 42 may prompt the user to identify an amount of game credits to be wagered on the selected game. In another embodiment, the system controller 42 may also display a “Bet Max” selection button 114 indicative of a predefined maximum amount of game credits, and/or a “Bet” selection button 116 indicative of a predefined minimum amount of game credits required to place a wager on the game.

In method step 210, the user account module 80 determines if the corresponding virtual credit account includes sufficient game credits to fund the requested wager. If the corresponding virtual credit account includes an amount of game credits equal to, or greater than, the wager amount, the system controller 42 proceeds to step 212 to play the game. If the corresponding virtual credit account includes an amount of game credits that is less than the requested wager amount, the system controller 42 display a notification message to the user indicating insufficient game credits and proceeds to step 202 to prompt the user to redeem additional consumer rewards for game credits.

In method step 212, the game module 84 determines the outcome of the selected game, displays the outcome of the selected game, and resolves the received wager as a function of the game outcome. In one embodiment, if the selected game is a casino-type game, the game module 84 randomly generates an outcome of the casino-type game 18 and resolves the wager as a function of the randomly generated game outcome. For example, if the selected game is a slot game, system controller 42 receives the wager from the user, determines the outcome of the slot-type game 88, and spins and stops the reels 94 to display the generated game outcome.

In method step 214, the game module 84 determines whether the game outcome is a winning outcome, and responsively, provides an award to the player as a function of the determined game outcome. In the illustrated embodiment, the award module 86 determines the outcome to be a winning outcome and proceeds to method step 216 to provide an award including an amount of game credits as a function of the determined outcome and a paytable, and updates the corresponding virtual credit account associated with the user. In another embodiment, the award module 86 may provide an award including one or more consumer rewards as a function of the determined game outcome. If game outcome is not a winning outcome, the system controller 42 proceeds to step 208 and prompts the user to place another wager on a subsequent play of the game.

In method step 218, the system controller 42 allows the user to play another round of the game or exchange game credits for consumer rewards. Upon receiving a request to play another game, the system controller 42 proceeds to step 208 and prompts the user to place another wager on a subsequent play of the game. Upon receiving a request from the user to exchange game credits, the system controller 42 proceeds to step 220.

In method step 220, the system controller 42 displays an exchange selection screen 118 (shown in FIG. 8) and receives an exchange request from the user to exchange an amount of virtual credits for at least one consumer reward. The exchange request includes an amount of virtual credits. For example, in the illustrated embodiment, the rewards module 82 identifies a plurality of exchangeable consumer rewards associated with the corresponding user profile account and determines a list of exchangeable consumer rewards a function of the amount of virtual credits included in the exchange request.

In method step 222, the system controller 42 displays the list of exchangeable consumer rewards to the user and allows the user to select at least one exchangeable consumer reward from the list of exchangeable consumer rewards. In one embodiment, the rewards module 82 determines an amount of game credits contained in the corresponding virtual credit account, and selects the exchangeable consumer rewards as a function of the determined amount of game credits. In another embodiment, the system controller 42 may allow the user to select an amount of game credits to be exchanged, and selects an amount of consumer rewards as a function of the selected amount of game credits. In the illustrated embodiment, the rewards module 82 determines an exchange rate associated with each exchangeable consumer reward displayed in the list of exchangeable consumer rewards, and determines a corresponding amount and/or type of consumer reward available for exchange as a function of the corresponding exchange rate and the selected amount of game credits. In addition, the rewards module 82 may display the amount and/or type of exchangeable consumer reward 74 to allow the user to select one or more consumer rewards for purchase with game credits.

In method step 224, the system controller 42 receives a user selection indicative of at least one exchangeable consumer reward, determines an exchange rate associated with the selected at least one exchangeable consumer reward, and provides the selected consumer reward as a function of the amount of virtual credits and the associated exchange rate. For example, in the illustrated embodiment, the rewards module 82 conducts a consumer reward purchase transaction including receiving a user selection of an exchangeable consumer reward, receiving an amount of game credits for use in purchasing the selected consumer reward, determining the amount of purchased consumer rewards as a function of the corresponding exchange rate, and providing the purchased consumer rewards to the user in exchange for the corresponding amount of game credits. In one embodiment, the rewards module 82 updates the corresponding user profile account to include the purchased consumer rewards and deduct the corresponding amount of game credits from the virtual credit account. In addition, the system controller 42 may transmit a message to the commercial retail entity indicative of the consumer rewards purchase transaction.

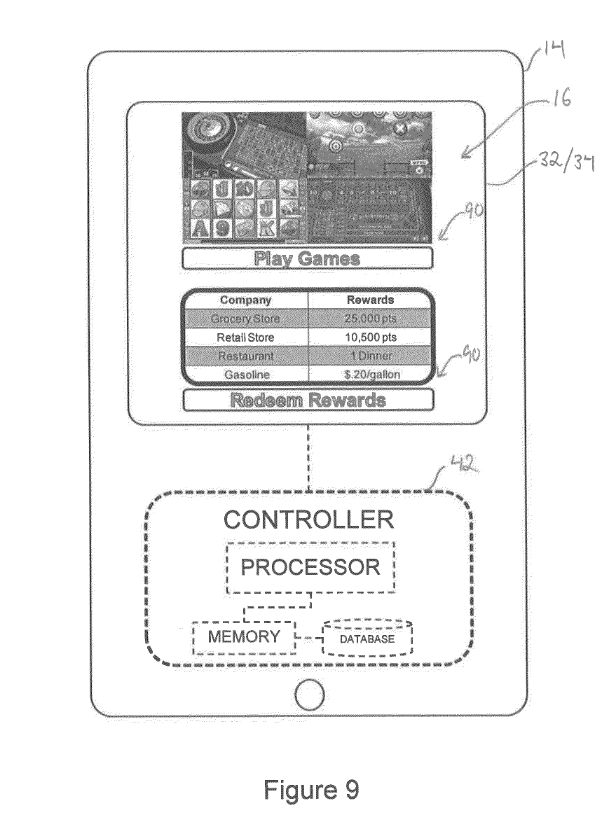

FIG. 9 is a schematic view of a user computing device 14 for allowing a player to play online casino-type games with consumer rewards, according to an embodiment of the invention. The user computing device 14 may be a smartphone, a personal computer, laptop, cell phone, tablet computer, smartphone/tablet computer hybrid, personal data assistant, and/or any suitable computing device that displays the graphical interfaces 16 and enables the user to play the casino-type game, to redeem consumer rewards for game credits for use in wagering on the casino-type games, and to exchange game credits for consumer rewards. In the illustrated embodiment, the user computing device 14 includes the display device 32, the user input device 34, and the controller 42 coupled to the display device 32 and the user input device 34.

The controller 42 includes a processor and a memory device and communicates with the server system 12 (shown in FIG. 1) via the network 22 and/or the cellular network 24. The controller 42 in particular executes a program to implement the method 200 and thereby conducts a consumer rewards program in accordance with the embodiments described herein. For example, in one embodiment, the controller 42 may transmit consumer rewards information and/or user profile account information to and/or from the server system 12 via the network 22.

The above-described systems and methods overcome at least some disadvantages of known consumer rewards systems by providing systems and methods that allow users to play online casino-type game with game credits purchased using consumer rewards. In addition, the system and methods provide an opportunity to increase an amount of consumer rewards available to a user by allowing the user to exchange a consumer reward for game credits, wager the game credits on the outcome of the casino-type games, and to exchange the game credits for different consumer rewards. By providing a system and method that allows a user to wager consumer rewards on online casino-type games, the probability of increasing the value of the consumer reward is increased and the enjoyment in the use of consumer rewards is increased, thus increasing the effectiveness of the consumer retention rewards program.

Exemplary embodiments of a system and method for providing online casino-type games with redeemable consumer rewards are described above in detail. The system and method are not limited to the specific embodiments described herein, but rather, components of the system and/or steps of the method may be utilized independently and separately from other components and/or steps described herein. For example, the system may also be used in combination with other wagering systems and methods, and is not limited to practice with only the system as described herein. Rather, an exemplary embodiment can be implemented and utilized in connection with many other wagering applications.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Those skilled in the art will readily appreciate that the systems and methods described herein may be a standalone system or incorporated in an existing gaming system. The system of the invention may include various computer and network related software and hardware, such as programs, operating systems, memory storage devices, data input/output devices, data processors, servers with links to data communication systems, wireless or otherwise, and data transceiving terminals. It should also be understood that any method steps discussed herein, such as for example, steps involving the receiving or displaying of data, may further include or involve the transmission, receipt and processing of data through conventional hardware and/or software technology to effectuate the steps as described herein. Those skilled in the art will further appreciate that the precise types of software and hardware used are not vital to the full implementation of the methods of the invention so long as players and operators thereof are provided with useful access thereto, either through a mobile device, gaming platform, or other computing platform via a local network or global telecommunication network.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A method of allowing a player to play a casino-type game, including the steps of:
receiving, via a user computing device, a redemption request from a user to redeem a consumer reward;
generating an amount of virtual credits as a function of the consumer reward in response to the received redemption request;
displaying a casino-type game on the user computing device;
allowing the user to place a wager on an outcome of the casino-type game, the wager including an amount of virtual credits;
determining an outcome of the casino-type game; and
resolving the wager as a function of the amount of virtual credits wagered and the casino-type game outcome.

2. A method in accordance with claim 1, including the steps of:
determining a redemption rate associated with the consumer reward, the redemption rate indicative of an equivalent amount of virtual credits; and
generating the amount of virtual credits as a function of the determined redemption rate.

3. A method in accordance with claim 1, including the steps of:
displaying a list of redeemable consumer rewards in response to the redemption request;
receiving a user selection indicative of at least one consumer reward contained in the list of redeemable consumer rewards; and
generating the amount of virtual credits as a function of the selected at least one consumer reward.

4. A method in accordance with claim 3, including the steps of:
determining a redemption rate associated with each of the redeemable consumer rewards contained in the list of redeemable consumer rewards; and
generating the amount of virtual credits as a function of the selected at least one consumer reward and the corresponding redemption rate.

5. A method in accordance with claim 4, wherein the list of redeemable consumer rewards includes a first consumer reward having a first redemption rate and a second consumer reward having a second redemption rate that is different than the first redemption rate.

6. A method in accordance with claim 1, including the steps of:
receiving an exchange request from the user to exchange an amount of virtual credits for at least one consumer reward, the exchange request including an amount of virtual credits;
determining a list of exchangeable consumer rewards as a function of the amount of virtual credits;
displaying the list of exchangeable consumer rewards to the user; and
allowing the user to select at least one exchangeable consumer reward from the list of exchangeable consumer rewards.

7. A method in accordance with claim 6, including the steps of:
receiving a user selection indicative of at least one exchangeable consumer reward;
determining an exchange rate associated with the selected at least one exchangeable consumer reward; and
providing the selected at least on consumer reward as a function of the amount of virtual credits and the associated exchange rate.

8. A system for allowing a user to play a casino-type game, comprising:
a user computing device, the user computing device including a user input device for accepting a user's selection input and a display device; and
a system controller coupled to the user computing device the system controller configured to:
receive, via the user computing device, a redemption request from a user to redeem a consumer reward;
generate an amount of virtual credits as a function of the consumer reward in response to the received redemption request;
display a casino-type game on the user computing device;
allow the user to place a wager on an outcome of the casino-type game, the wager including an amount of virtual credits;
determine an outcome of the casino-type game; and
resolve the wager as a function of the amount of virtual credits wagered and the casino-type game outcome.

9. A system in accordance with claim 8, the system controller configured to:
determine a redemption rate associated with the consumer reward, the redemption rate indicative of an equivalent amount of virtual credits; and
generate the amount of virtual credits as a function of the determined redemption rate.

10. A system in accordance with claim 8, the system controller configured to:
display a list of redeemable consumer rewards in response to the redemption request;
receive a user selection indicative of at least one consumer reward contained in the list of redeemable consumer rewards; and
generate the amount of virtual credits as a function of the selected at least one consumer reward.

11. A system in accordance with claim 10, the system controller configured to:
determine a redemption rate associated with each of the redeemable consumer rewards contained in the list of redeemable consumer rewards; and
generate the amount of virtual credits as a function of the selected at least one consumer reward and the corresponding redemption rate.

12. A system in accordance with claim 11, wherein the list of redeemable consumer rewards includes a first consumer reward having a first redemption rate and a second consumer reward having a second redemption rate that is different than the first redemption rate.

13. A system in accordance with claim 8, the system controller configured to:
receive an exchange request from the user to exchange an amount of virtual credits for at least one consumer reward, the exchange request including an amount of virtual credits;
determine a list of exchangeable consumer rewards as a function of the amount of virtual credits;
display the list of exchangeable consumer rewards to the user; and
allow the user to select at least one exchangeable consumer reward from the list of exchangeable consumer rewards.

14. A system in accordance with claim 13, the system controller configured to:
receive a user selection indicative of at least one exchangeable consumer reward;
determine an exchange rate associated with the selected at least one exchangeable consumer reward; and
provide the selected at least on consumer reward as a function of the amount of virtual credits and the associated exchange rate.

15. One or more non-transitory computer-readable storage media, having computer-executable instructions embodied thereon, wherein when executed by at least one processor, the computer-executable instructions cause the processor to:
receive a redemption request from a user to redeem a consumer reward;
generate an amount of virtual credits as a function of the consumer reward in response to the received redemption request;
display a casino-type game on the user computing device;
allow the user to place a wager on an outcome of the casino-type game, the wager including an amount of virtual credits;
determine an outcome of the casino-type game; and
resolve the wager as a function of the amount of virtual credits wagered and the casino-type game outcome.

16. The one or more computer-readable storage media according to claim 15, wherein when executed by at least one processor, the computer-executable instructions cause the processor to:
determine a redemption rate associated with the consumer reward, the redemption rate indicative of an equivalent amount of virtual credits; and
generate the amount of virtual credits as a function of the determined redemption rate.

17. The one or more computer-readable storage media according to claim 15, wherein when executed by at least one processor, the computer-executable instructions cause the processor to:
display a list of redeemable consumer rewards in response to the redemption request;
receive a user selection indicative of at least one consumer reward contained in the list of redeemable consumer rewards; and
generate the amount of virtual credits as a function of the selected at least one consumer reward.

18. The one or more computer-readable storage media according to claim 17, wherein when executed by at least one processor, the computer-executable instructions cause the processor to:
determine a redemption rate associated with each of the redeemable consumer rewards contained in the list of redeemable consumer rewards; and
generate the amount of virtual credits as a function of the selected at least one consumer reward and the corresponding redemption rate.

19. The one or more computer-readable storage media according to claim 18, wherein the list of redeemable consumer rewards includes a first consumer reward having a first redemption rate and a second consumer reward having a second redemption rate that is different than the first redemption rate.

20. The one or more computer-readable storage media according to claim 15, wherein when executed by at least one processor, the computer-executable instructions cause the processor to:
receive an exchange request from the user to exchange an amount of virtual credits for at least one consumer reward, the exchange request including an amount of virtual credits;
determine a list of exchangeable consumer rewards as a function of the amount of virtual credits;
display the list of exchangeable consumer rewards to the user; and
receive a user selection indicative of at least one exchangeable consumer reward;
determine an exchange rate associated with the selected at least one exchangeable consumer reward; and
provide the selected at least on consumer reward as a function of the amount of virtual credits and the associated exchange rate.
